(19) United States
(12) Patent Application Publication
(10) Pub. No.: US 2003/0007279 A1
(43) Pub. Date: Jan. 9, 2003

(54) In-situ fly height measurement device for a magnetic disk drive slider

(76) Inventors: Paul Johnson, Kaysville, UT (US); Mark Thornley, Layton, UT (US); Kristin A.M. Scott, Ogden, UT (US); Yiping Ma, Layton, UT (US)

Correspondence Address: Richard E. Kurtz, Esquire, WOODCOCK WASHBURN KURTZ, MACKIEWICZ & NORRIS LLP, One Liberty Place - 46th Floor, Philadelphia, PA, 19103, US

(21) Appl. No.: 09/900,107

(22) Filed: Jul. 6, 2001

(51) Int. Cl. G11B 21/02; G11B 5/02

(52) U.S. Cl. 360/75; 360/25

(57) ABSTRACT

A data recording system has a displacement sensitive optical element on the slider carrying read/write heads into engagement with a recording medium. The displacement sensitive optical element includes a laser diode and a semiconductor detector of laser light emitted by the diode and reflected from the recording medium.

### FIELD OF THE INVENTION

This invention relates to data storage disk drives and a system for testing disk drives. More particularly it relates to measuring the fly height of a slider carrying the read/write heads over the recording medium.

### BACKGROUND OF THE INVENTION

Maximizing the reliability of data stored in disk drives, both magnetic and optical, is a key objective of disk drive designers. The reliability with which data is written to the recording medium is heavily dependent upon the spacing between the read/write head and the recording medium. A “phantom write” is a non-recoverable data error caused by temporary spacing loss during a write. This leads to a greater need for the type of automatic transient error detection method described in U.S. Pat. No. 5,588,007, Ma. That patent describes a method for detecting transient write errors based on difficulty in reading pre-recorded information on the disk such as servo marks, ID marks and others. High write errors are a primary source of uncorrectable data errors experienced in disk drives such as the JAZ® and ZIP® drives supplied by Iomega Corporation. Such errors are to believed to be a major problem for all data storage drive products.

U.S. Pat. No. 4,860,276 Ukita et al, shows a laser and a photo detector mounted on a slider as a read/write element for an optical data storage product. Data detection was accomplished by monitoring the amount of light feedback into the laser die from light and dark reflective marks on the disk with the photo detector. Laser feedback is not only sensitive to changes in reflectance but also to changes in physical spacing from a reflector. While Ukita et al make note of the spacing dependence on signal, they do not disclose its use as a spacing detector.

The output signal as a function of spacing distance is a nonlinear, sinusoidal-type function with multiple peaks of decreasing amplitude as the distance increases (See FIG. 11 of the Ukita et al patent). In the simplest application of this optical spacing detector, the detection range is restricted to the linear portion on either the rising or falling slope of one of the peaks. The peak amplitude and separation between the peaks are a function of the laser wavelength, laser facet material and disk materials. Kim et al., in their paper “An open resonator model for the analysis of a short external cavity laser and its application to an optical disk head”, (IEEE Journal of Lightwave Technology, vol. 10, no. 4, April 1992, pp. 439-447) derive equations that model Ukita's optical read/write head for data detection. They can be used as a predictive model for the practical implementation of a laser/detector system, mounted on a slider for optical spacing detection.

Another approach that uses light feedback as a method for optical spacing detection is an optical probe. Optical probes, such as the MTI 1000 Fotonic Sensor, are used as non-contact displacement measurement systems. Light transmitted down a fiber optical probe bundle is reflected back into the probe in proportion to the distance from the target surface. The probe, in general, is larger than a typical hard disk magnetic head and so it cannot be mounted or coupled to the slider and used “as is”. (For example, a “pico” slider is 0.49×0.039×0.012×inches³). One single fiber rather than a fiber bundle (for example a single-mode fiber) has a more compatible diameter (100 microns) to be coupled to a slider body. It is possible, with currently practiced micro-assembly techniques, to mount an optical fiber onto a slider, since the process requires the same positioning accuracy and similar materials as that used for fiber optical network components. At the other end of the fiber would be an emitter/receiver pair and necessary optics to focus/collect the light into the fiber.

It is an object of the present invention to provide a reliable method of monitoring the fly height of a slider on which the read/write heads are positioned.

### SUMMARY OF THE INVENTION

In accordance with the present invention a displacement sensitive optical element is mounted on a slider having a read/write head for reading/writing during relative motion between the slider and a recording medium. The displacement sensitive element produces an output indicating the distance of the read/write head from the medium. This invention provides continuous real time monitoring of the fly height of the recording heads over the recording media. It in turn enables the detection of phantom write errors #(otherwise called “high write errors”) that are caused by contamination, media surface asperity and head-disk-interface stability. The output of the photo-detector is fed into a comparator circuit which generates an error signal if the fly height variance exceeds a programmed threshold. The error signal is monitored and the write is aborted upon an error signal. When the write fault is detected a retry is attempted using write verify.

Further in accordance with the invention the displacement sensitive optical element is a laser diode with a semi-conductor detector of laser light emitted by the diode and reflected from the recording medium.

Integrating a semiconductor diode laser and detector into a single element appears attractive visually and reduces the number of needed components by one. Using separate, and more commonly found, laser diode and detector semiconductor chips is an equally good implementation of the invention.

Further the change in voltage across the laser diode can be monitored without a semiconductor detector, since the voltage will change with the amount of optical feedback into the laser cavity. In this case, the semiconductor detector is not necessary. Practically speaking however, the electronics to measure the voltage change may limit the speed of the rest of the circuitry to the slider head. So it is preferred to have a semiconductor detector to monitor the rear facet output power, rather than measure the voltage change across the laser diode. The laser diode and detector can be separate elements, with the detector in proximity to the rear facet of the laser diode, or combined into a single element.

Further in accordance with the invention, the displacement sensitive optical element is an emitter/receiver pair operating in the front portion of the response curve, i.e. the output of the sensor increases with distance. Further in accordance with the invention the emitter/receiver pair operates in the back portion of the response curve, i.e. the output varies with the square of the distance.

The foregoing and other objects, features of the advantages will be better understood from the more detailed description and appended claims.

### BRIEF DESCRIPTION OF THE DRAWINGS

FIG. 1 is a plan view of a flexible disk, and a flexure with a planar ramp read/write transducer;

FIG. 2 shows the rails, electromagnetic element, cross-cut slots and ramps, laser and photo detector;

FIG. 3 is an enlarged view of the flexures, media and rail with dimensions and angles greatly exaggerated;

FIGS. 4A-4C show plan, edge and side views of the slider with the displacement sensitive element

FIG. 5 shows the output signal of the displacement sensitive element as a function of fly height;

FIG. 6 shows the feedback signal from a laser as a function of distance away from a hard disk; and

FIG. 6A shows the output signal of the Ukita et al detector; and

FIG. 7 shows the fly height monitor of the present invention implemented in a disk drive.

### DESCRIPTION OF THE PREFERRED EMBODIMENT

The preferred embodiment uses a rigid disk for the media but can also be used with a flexile media storage system of the type shown in U.S. Pat. No. 5,636,085, Jones et al. What is required is that a reflected portion of the emitted laser light from the media couples into the front facet of the laser. The type of media is irrelevant as long as it is somewhat reflective.

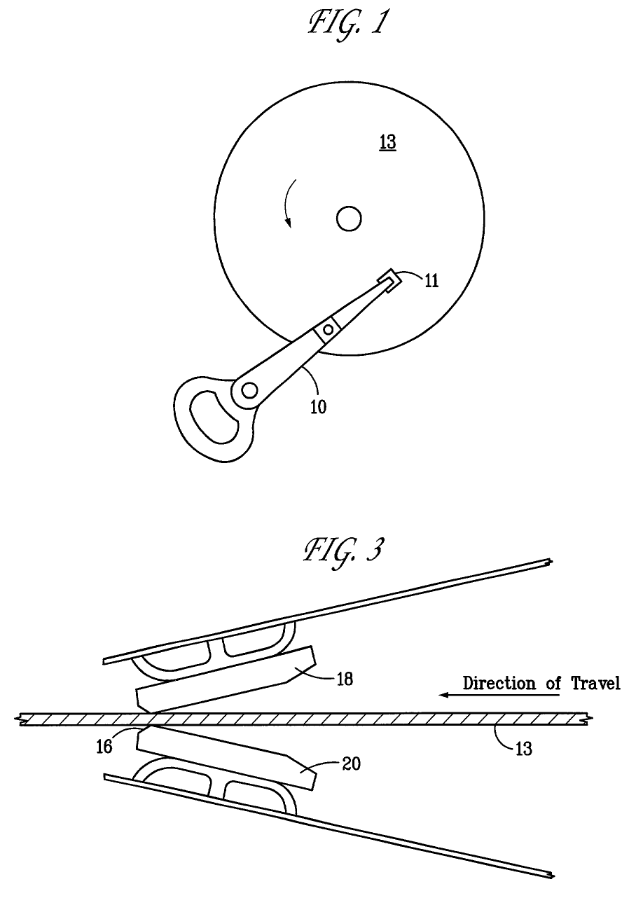

FIG. 1 shows a typical rotary arm 10 carrying a slider 11 with read/write elements into engagement with a rigid medium 11.

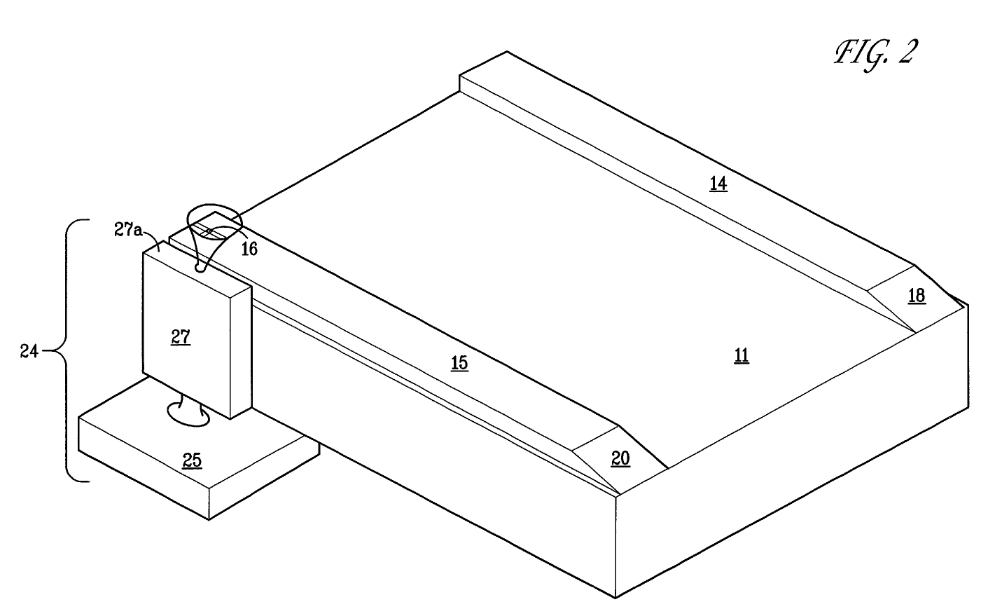

FIG. 2 is a view of the slider 11 with magnetic read/write element 16 integrated into the trailing edge of one of the rails 14 and 15. Attached to the side of the slider is the semiconductor laser diode 27. Its dimensions are approximately 0.5 mm×0.4 mm×0.1 m (L×W×H). The front facet 27a of the laser is closest to the slider rail 15. That facet is 0.4 mm×0.1 mm in an exemplary embodiment. The rear facet of the laser is opposite the front facet. The photodetector 25 is located behind the rear facet of the laser, with the photosensitive area positioned to collect light emitted from the laser rear facet. Light reflected from the disk surface is incident upon the front facet 27a. Longitudinal rails 14 and 15 on the slider 11 extend in the direction of movement of the media. Each rail has a width which extends perpendicular to the direction of movement of the media. An electromagnetic read/write element 16 extends partially, or fully, across the width of the rail or rails, at the trailing longitudinal end of the rail. Bevels 18 and 20 are on the leading edge of each rail. As best shown in FIG. 3 each of the rails is at an angle to the media with the leading end thereof further from the media than the trailing edge.

In accordance with the present invention a displacement sensitive optical element 24 including laser 27 and photodetector 25 is positioned on the slider in close proximity to the read/write head 16. The detector 25 produces an output indicating the distance of read/write head 16 from the medium.

In accordance with one aspect of the invention, the displacement sensitive element includes an edge-emitting laser diode and a semi-conductor detector. An exemplary component part for the laser diode is that packaged in Sharp model #LT022, but any laser diode of sufficient output power and with an anti-reflective coating on the front facet (reflectivity R<1%) will perform according to the invention. A possible component for the semiconductor detector is Hammamatsu model #S5970 series, but any detector with a rise time (rise time=signal increase from 10-90% of maximum signal) of a few nanoseconds or less will be sufficiently accurate to sense the temporal changes in laser feedback power from the rear facet of the laser diode. Prototype integrated laser/detector elements have been fabricated, although not generally available at this time in commercial quantities. Mounting and aligning a single element greatly simplifies the assembly onto the slider and is included in this invention.

The front facet of the laser needs to be in the plane of or slightly recessed from the flat air bearing surfaces of the slider. The distance is typically a small fraction of the wavelength of light being used, but large enough to account for slider life-time wear and laser to slider dimensional creep. For example, in a laser having a 780 nm wavelength, the maximum distance is about 390 nm or 15.6 micro-inches. From such numbers a typical mounting specification is determined for the nominal mounting location of the front surface of the laser relative to the trailing surface of the air bearing surface of the slider. In some laser diodes, the wavelength, λ, is about 980 nm. Hence the distance must be less than about 490 nm. In addition to the other tolerances, the angles of the light beam should be maintained as perpendicular to the disk surface as is possible.

Typically, the slider has a flying height that is a function of the air bearing design. A current state of the art air bearing produces a flying height of about 20 nm. Other factors may contribute to the tolerances, such as the material chosen for the protective coating and the anti-reflective coating on the face of the laser diode. Such materials have an index of refraction that may shorten the wavelength of light thus making the placement of the laser chip more critical.

Hence, the laser chip must be placed on the slider with extremely tight tolerances and in a repeatable manner that lends itself to volume production. The detector must be placed in proximity to the rear facet of the laser chip so that a portion of the emitted light falls on the sensitive area of the detector. Given sufficient signal from the detector in proportion to the incident light, tight tolerances are not necessary with this component.

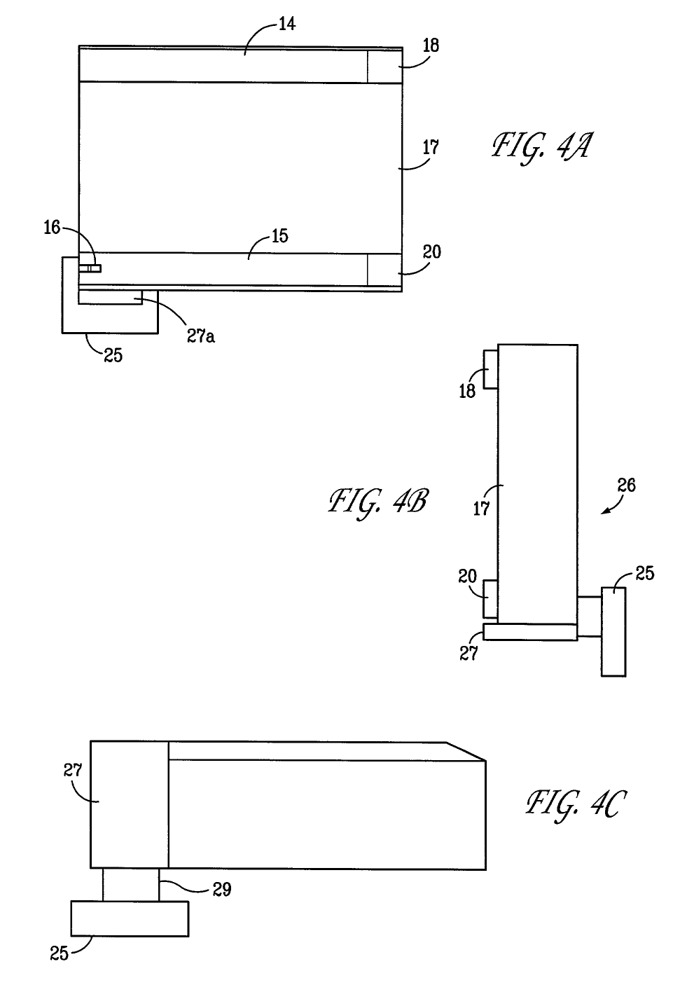

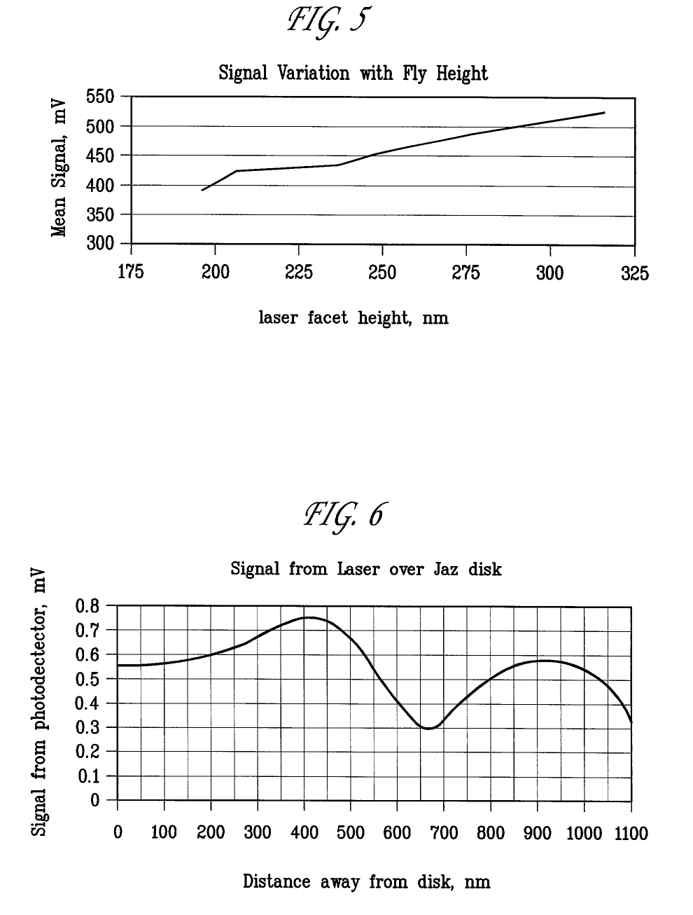

FIGS. 4A-4C show top, rear and side views of the slider of the present invention. The rear and side views show the photodetector 25 suspended away from the rear facet of the laser diode 27 by suspension 29. It is possible to make the slider thicker so as to attach the photodetector to the slider without interfering with the laser diode placement. The photodetector can be mounted and held in place with a flex-circuit or other suspension. Either way, these drawings show the relative placement of the parts necessary for the invention.

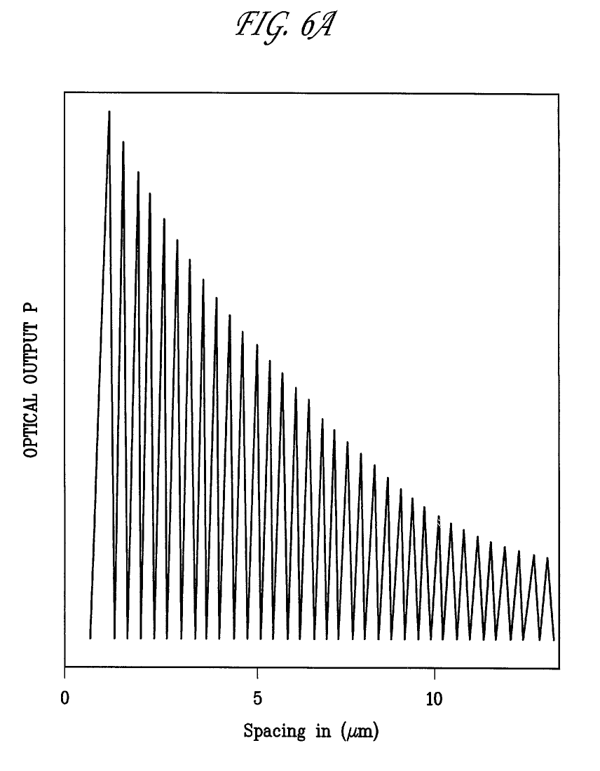

FIG. 5 shows the change in feedback signal from the detector of a laser diode attached to a slider as a function of the slider flying height. The laser facet height is the sum of the slider fly height and the laser recession from the air bearing surface of the slider.

The graph shows the change in feedback signal as measured by a silicon photodiode as the fly height above a rigid disk was changed by 120 nm. The change in feedback depicted in the graph is an increase with increasing fly height. A decrease in signal with an increase in fly height can also be configured by adjusting the placement of the laser diode on the slider to the appropriate distance from the media. The silicon photodiode was not integrated into the head assembly in this example, but the attachment of one to the slider or similar light sensor is considered part of the invention.

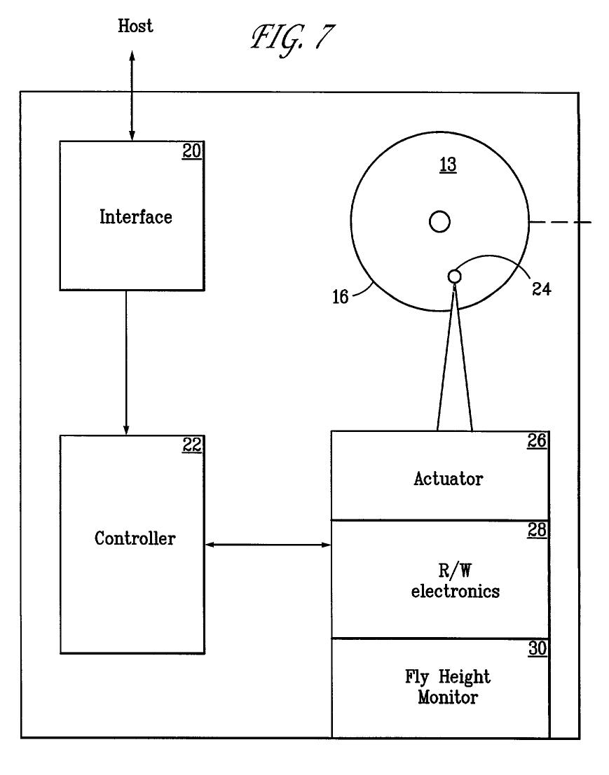

FIG. 6 shows the feedback signal from a laser as a function of distance away from a hard disk, in this case, a JAZ® disk. The phase oscillations have a peak to peak separation. The phase oscillations have a peak-to-peak separation of about λ/2. A typical write error can be caused by a 30% change in fly height. For a 100 nm flying head a change of 30 nm would represent a ⅔ division on the graph. As the fly-height reduces the sensitivity can be scaled appropriately by changing the laser placement, laser wavelength, and read circuitry. The laser can be positioned on the slider to get either an increasing or decreasing signal with distance.

FIG. 6A is from U.S. Pat. No. 4,860,276 Ukita et al. The output signal P, as a function of spacing distance, h, is a nonlinear, sinusoidal-type function with multiple peaks of decreasing amplitude as the distance increases. Compare FIG. 6A to FIG. 6, where the x-axis covers 1100 nm or 1.1 microns of distance. FIG. 6A covers about 15 microns of distance, which is why many more peaks appear. It is apparent from FIG. 6A that to get the highest signal-to-noise ratio, the laser must be placed within a few microns of the disk surface.

As an alternative to the laser diode/detector pair just described, an emitter/receiver pair which works on the same principle as the Fotonic sensor may be used. The Fotonic sensor is described in the MTI 1000 brochure which is available from that company. Such an emitter/receiver pair operates on the front portion of the response curve, i.e. where the output increases with distance, or on the back portion of the response curve, that is where the output decreases with the square of the distance.

FIG. 7 shows the in situ fly height detector implemented in a disk drive which includes an interface 20 interconnecting the disk drive to a host computer, a controller 22 for controlling the actuator 26 and read/write electronics 28. Displacement sensitive optical element 24 is connected through read/write electronics 28 to the fly height monitor 30 of the present invention. In response to an output such as shown in FIG. 5 or 6, monitor 30 continuously monitors fly height, or it detects phantom writes, or it provides a continuous monitor of disk surface quality. The present invention may be incorporated in test stands such as a Guzik brand media tester. The invention may be used in data-industry test equipment as well as for consumer-type products.

While particular embodiments have been shown and described, various modifications may be made. The appended claims are therefore, intended to cover all such modifications withing the true spirit and scope of the invention.

What is claimed is:

1. A data recording system in which data is written/read to/from a recording medium comprising:
a slider having a read/write head for writing/reading data during relative motion between said slider and said medium; and
a displacement sensitive optical element on said slider in close proximity to said read/write head, said element producing an output indicating the distance of said head from said medium.

2. The data recording system recited in claim 1 wherein said optical element comprises:
a laser diode; and
a semiconductor detector of laser light emitted by said diode and reflected from said recording medium.

3. The data recording system recited in claim 1 in which data is written/read to/from a magnetic recording medium.

4. The data recording system recited in claim 1 wherein the output of said displacement sensitive optical element increases with distance from said medium.

5. The data recording system recited in claim 1 wherein the output of displacement sensitive optical element decreases with the square of the distance from said medium.

6. The data recording system recited in claim 1 further comprising:
a monitor for continuously monitoring the fly height of said slider, the output of said displacement sensitive optical element being connected to said monitor.

7. The data recording system recited in claim 1 further comprising:
a phantom write detector, the output of said displacement sensitive optical element being connected to said phantom write detector.

8. The data recording system recited in claim 1 further comprising:
a disk surface quality monitor, the output of said displacement sensitive optical element being connected to said disk surface quality monitor.

9. A recording medium tester comprising:
a slider having a read/write head for writing/reading data during relative motion between said slider and said medium; and
a displacement sensitive optical element on said slider in close proximity to said read/write head, said element producing an output indicating the distance of said head from said medium.

10. The recording medium tester recited in claim 9 wherein said optical element comprises:
a laser diode; and
a semiconductor detector of laser light emitted by said diode and reflected from said recording medium.

11. The recording medium tester recited in claim 9 in which data is written/read to/from a magnetic recording medium.

12. The recording medium tester recited in claim 9 wherein the output of said displacement sensitive optical element increases with distance from said medium.

13. The recording medium tester recited in claim 9 wherein the output of displacement sensitive optical element decreases with the square of the distance from said medium.

14. The recording medium tester recited in claim 9 further comprising:
a monitor for continuously monitoring the fly height of said slider, the output of said displacement sensitive optical element being connected to said monitor.

15. The recording medium tester recited in claim 9 further comprising:
a phantom write detector, the output of said displacement sensitive optical element being connected to said phantom write detector.
